(19) United States
(12) Patent Application Publication
(10) Pub. No.: US 2009/0075137 A1
(43) Pub. Date: Mar. 19, 2009

(54) Filter, hydrogen generator and fuel cell power generation system having the same

(75) Inventors: Bo-Sung Ku, Suwon-si (KR); Jae-Hyuk Jang, Seongnam-si (KR); Kyoung-Soo Chae, Suwon-si (KR); Jae-Hyoung Gil, Seoul (KR); Chang-Ryul Jung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/232,314

(22) Filed: Sep. 15, 2008

(30) Foreign Application Priority Data
Sep. 18, 2007 (KR) 10-2007-0094933
Dec. 17, 2007 (KR) 10-2007-0132666

(51) Int. Cl. H01M 4/00; B01D 24/00; C25B 9/00

(52) U.S. Cl. 429/27; 55/522; 204/242

(57) ABSTRACT

A filter, and a hydrogen generator and a fuel cell power generation system having the filter, are disclosed. The filter includes a frame, in which an opening is formed each in two sides; a cover, which is coupled to the opening, and in which at least one hole is formed to allow the gas to pass; and a desiccant, which is filled inside the frame, and which absorbs the moisture. By using such a filter, the backflow of the electrolyte solution, which may occur while generating hydrogen, can be prevented, by passing the hydrogen through a desiccant filled inside a frame, to consequently increase the hydrogen generating efficiency of the hydrogen generator.

### CROSS-REFERENCE TO RELATED APPLICATIONS

This application claims the benefit of Korean Patent Application No. 10-2007-0094933 and No. 10-2007-0132666 filed with the Korean Intellectual Property Office on Sep. 18, 2007, and Dec. 17, 2007, respectively, the disclosure of which are incorporated herein by reference in their entirety.

### BACKGROUND

1. Technical Field

The present invention relates to a filter, and to a hydrogen generator and fuel cell power generation system having the filter.

2. Description of the Related Art

A fuel cell is an apparatus that converts the chemical energies of fuel (hydrogen, LNG, LPG, methanol, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is a relatively new technology for generating power, which offers high efficiency and few environmental problems.

Examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly. The PEMFC provides a high output density, but requires a separate apparatus for supplying hydrogen. Using a hydrogen storage tank, etc., for supplying the hydrogen can result in a large volume and can require special care in handling and keeping. Methods used in generating hydrogen for a polymer electrolyte membrane fuel cell (PEMFC) can be divided mainly into methods utilizing the oxidation of aluminum, methods utilizing the hydrolysis of metal borohydrides, and methods utilizing reactions on metal electrodes. Among these, one method of efficiently regulating the rate of hydrogen generation is the method of using metal electrodes. This is a method in which the electrons obtained when magnesium in the electrode 220 is ionized to Mg²⁺ ions are moved through a wire and connected to another metal object, where hydrogen is generated by the dissociation of water. The amount of hydrogen generated can be regulated, as it is related to the distance between electrodes and the sizes of the electrodes.

However, when generating hydrogen by a method of generating hydrogen according to the related art, there is a problem of the reaction solution flowing backwards to the fuel cell stack. Thus, there is a need for a filter that prevents this backflow when generating hydrogen, and for a hydrogen generator and fuel cell generation system that use such a filter.

### SUMMARY

One aspect of the invention provides a filter, as well as a hydrogen generator and a fuel cell that use such a filter, in which the backflow of the electrolyte solution is prevented during the generation of hydrogen, by having the hydrogen pass through a desiccant placed inside the frame.

Another aspect of the invention provides a filter configured to remove moisture carried in a gas. The filter includes: a frame, in which an opening is formed each in two sides; a cover, which is coupled to the opening, and in which at least one hole is formed to allow the gas to pass; and a desiccant, which is filled inside the frame, and which absorbs the moisture.

The desiccant may include a plurality of porous grains.

The desiccant may include at least one selected from a group consisting of silica, zeolite, microporous glass, and microporous charcoal.

The desiccant may include an aerogel.

The desiccant may include at least one of sulfur (S) and selenium (Se).

The size of the holes may be smaller than that of the porous grains.

In certain embodiments, the filter may further include a detour plate inserted in the desiccant that detours the movement path of the gas.

Still another aspect of the invention provides a hydrogen generator which dissociates an electrolyte solution to generate hydrogen. The hydrogen generator includes: an electrolyte bath containing the electrolyte solution; an anode coupled inside the electrolyte bath that generates electrons; a cathode coupled inside the electrolyte bath that receives the electrons from the anode to generate hydrogen; a frame, to which the electrolyte bath is coupled, and on two sides of which an opening is formed each; a cover, which is coupled to the opening, and in which at least one is hole formed to allow the hydrogen to pass through; and a desiccant filled inside the frame that absorbs the electrolyte solution carried in the hydrogen.

The desiccant may include a plurality of porous grains.

The desiccant may include at least one selected from a group consisting of silica, zeolite, microporous glass, and microporous charcoal.

The desiccant may include an aerogel.

The desiccant may include at least one of sulfur (S) and selenium (Se).

The size of the holes may be smaller than that of the porous grains.

In certain embodiments, the hydrogen generator may further include a detour plate inserted in the desiccant that detours the movement path of the gas.

Also, a control unit may further be included, which is electrically connected with the anode and the cathode, and which is configured to control the flow of electricity between the anode and the cathode.

Yet another aspect of the invention provides a fuel cell power generation system configured to produce electrical energy using hydrogen generated by dissociating an electrolyte solution. The fuel cell power generation system includes: an electrolyte bath containing the electrolyte solution; an anode coupled inside the electrolyte bath that generates electrons; a cathode coupled inside the electrolyte bath that receives the electrons from the anode to generate hydrogen; a frame, to which the electrolyte bath is coupled, and on two sides of which an opening is formed each; a cover, which is coupled to the opening, and in which at least one is hole formed to allow the hydrogen to pass through; a desiccant filled inside the frame that absorbs the electrolyte solution carried in the hydrogen; and a fuel cell, which converts the chemical energy of the hydrogen produced at the cathode to produce electrical energy.

The desiccant may include a plurality of porous grains.

The desiccant may include at least one selected from a group consisting of silica, zeolite, microporous glass, and microporous charcoal.

The desiccant may include an aerogel.

The desiccant may include at least one of sulfur (S) and selenium (Se).

The size of the holes may be smaller than that of the porous grains.

In certain embodiments, the fuel cell power generation system may further include a detour plate inserted in the desiccant that detours the movement path of the gas.

Also, a control unit may further be included, which is electrically connected with the anode and the cathode, and which is configured to control the flow of electricity between the anode and the cathode.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view illustrating an embodiment of a filter according to an aspect of the present invention.

FIG. 2 is a cross-sectional view illustrating an embodiment of a filter according to an aspect of the present invention.

FIG. 3 is a perspective view illustrating an embodiment of a hydrogen generator according to another aspect of the present invention.

FIG. 4 is an exploded perspective view illustrating an embodiment of a hydrogen generator according to another aspect of the present invention.

FIG. 5 is a schematic diagram illustrating an embodiment of a fuel cell power generation system according to yet another aspect of the present invention.

### DETAILED DESCRIPTION

The filter, and the hydrogen generator and fuel cell power generation system having the filter, according to certain aspects of the invention will be described below in more detail with reference to the accompanying drawings, in which those components are rendered the same reference numeral that are the same or are in correspondence, regardless of the figure number, and redundant explanations are omitted.

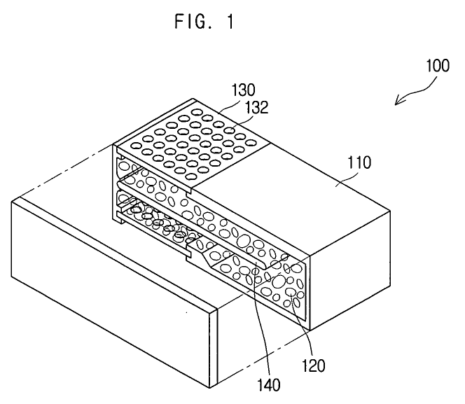

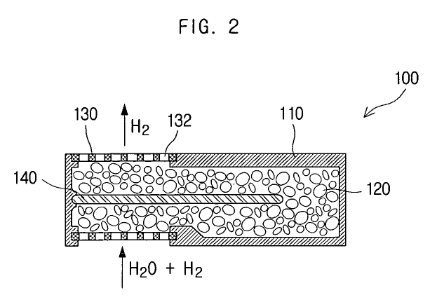

FIG. 1 is a perspective view illustrating an embodiment of a filter according to an aspect of the present invention, and FIG. 2 is a cross-sectional view illustrating an embodiment of a filter according to an aspect of the present invention. In FIGS. 1 and 2 are illustrated a filter 100, a frame 110, a desiccant 120, covers 130, holes 132, and a detour plate 140.

In this embodiment, a filter 100 is presented, which prevents the backflow of moisture towards the hydrogen generator, by removing the moisture carried in the gas using a desiccant 120 filled inside a frame 110.

The frame 110 may have the desiccant 120 filled inside, and may have openings formed on two sides. Thus, as a gas, e.g. hydrogen, that includes moisture, such as from an electrolyte solution, passes the desiccant 120, the moisture carried in the gas, e.g. hydrogen, can be removed.

The covers 130 may each be coupled to the openings formed in the frame 110, and holes 132 may be formed in the covers 130 positioned in two sides, to allow a gas, e.g. hydrogen, to pass through. Also, the size of the holes 132 formed in the covers 130 can be smaller than the porous grains that make up the desiccant 120. In this way, the porous grains may not pass through the holes 132 and instead may be supported by the covers 130, to absorb the moisture carried in the gas, e.g. hydrogen.

While this embodiment presents the case where the covers 130 and the frame 110 are made as separate components, it is apparent that the invention encompasses such cases where the covers 130 and frame 110 are fabricated as an integrated or single body, according to the processes for manufacturing the filter 100.

The desiccant 120 can be made of a plurality of porous grains, and can be filled inside the frame 110, so as to absorb moisture carried in a gas, e.g. hydrogen. The desiccant 120 may include tiny pores of minute size distributed in each grain, and thus may readily absorb moisture, such as from an electrolyte solution. Gases such as hydrogen, however, may readily pass between these desiccant 120 grains or through the inner pores, to be exhausted to the outside without causing a substantial increase in pressure.

Accordingly, the desiccant 120 can be made of a molecular sieve, and can include any one of silica, zeolite, microporous glass, and microporous charcoal, or combinations of two or more such ingredients.

Also, the desiccant 120 can include an aerogel, where the aerogel particles may also provide a porous structure to readily absorb moisture, such as from the electrolyte solution.

The desiccant 120 made of aerogel particles may contain sulfur (S) or selenium (Se) or both. With the inclusion of sulfur or selenium, impurities such as heavy metal ions and salts, etc., carried in the gas, e.g. hydrogen, may be removed, and as a result, the gas may be obtained with a greater level of purity.

A detour plate 140 may be inserted in among the desiccant 120 and may detour the movement path of a gas, e.g. hydrogen. That is, one side of the detour plate 140 may be coupled to an inner surface of the frame 110, such that the detour plate 140 may be inserted between the multiple porous grains, so that when a gas, e.g. hydrogen, moves from the opening formed in one side of the frame 110 to the opening formed in the other side, it may be blocked by the detour plate 140, and the path of the gas may be lengthened. The gas, e.g. hydrogen, may then maintain more contact with the desiccant 120, whereby the moisture can be removed with greater effectiveness.

While this embodiment presents the case where the detour plate 140 is coupled inside the frame 110 as a separate component, it is apparent that the invention encompasses such cases where the frame 110 and the detour plate 140 are fabricated as an integrated or single body, according to the processes for manufacturing the filter 100.

According to this embodiment, by using a desiccant 120 made up of a plurality of porous grains, moisture carried in a gas, for example, hydrogen, can effectively be removed. Also, by using a detour plate 140, the movement path of a gas, for example, hydrogen, can be lengthened, to more effectively remove the moisture carried in a gas, e.g. hydrogen, and provide pure hydrogen.

Next, an embodiment will be described of a hydrogen generator according to another aspect of the present invention.

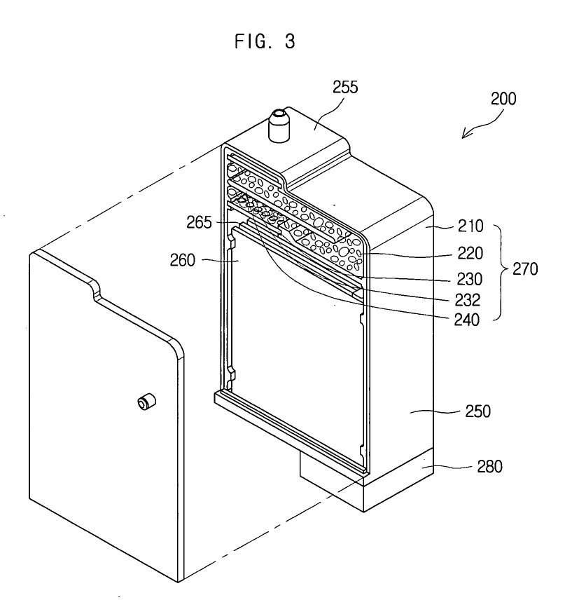

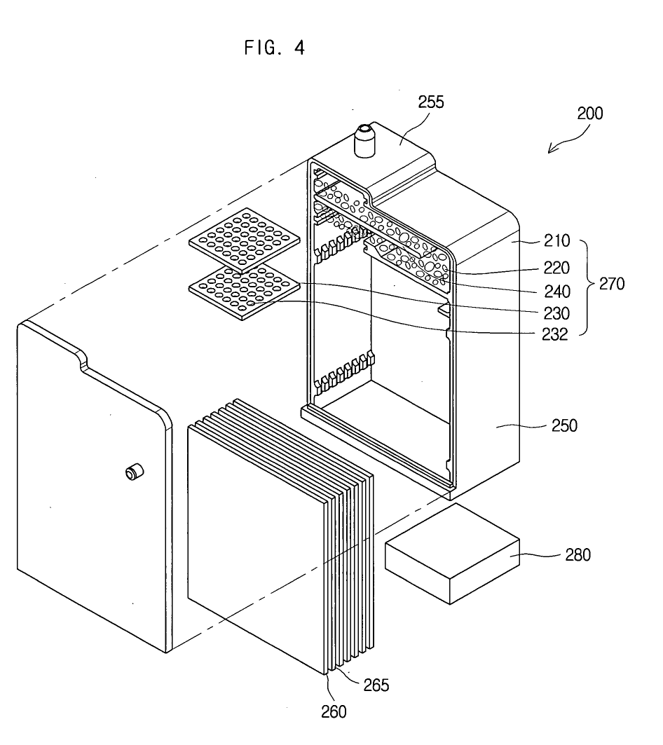

FIG. 3 is a perspective view illustrating an embodiment of a hydrogen generator according to another aspect of the present invention, and FIG. 4 is an exploded perspective view illustrating an embodiment of a hydrogen generator according to another aspect of the present invention. In FIGS. 3 and 4 are illustrated a hydrogen generator 200, an electrolyte bath 250, an outlet 255, anodes 260, cathodes 265, a filter 270, a frame 210, a desiccant 220, covers 230, holes 232, a detour plate 240, and a control unit 280.

This embodiment presents a hydrogen generator 200, which prevents the electrolyte solution in the electrolyte bath 250 from flowing back with the generated hydrogen, by removing the moisture carried in the gas using a desiccant 220 supported by the frame 210 and covers 230.

In this embodiment, the frame 210, desiccant 220, covers 230, holes 232, and detour plate 240 are substantially the same as or are in correspondence with the components of the embodiment described above (FIG. 1) according to an aspect of the invention, and thus will not be described again. The descriptions that follow will focus on the compositions, coupling relationships, and functions of the electrolyte bath 250, anodes 260, cathodes 265, and control unit 280, which form the differences from the previously described embodiment.

The electrolyte bath 250 may contain an electrolyte solution that produces hydrogen by dissociation. An opening may be formed in one side of the electrolyte bath 250, and the filter 270 may be coupled to this opening. An outlet 255 may be coupled to the frame 210 above the cover 230 of the filter 270 on the side where hydrogen is outputted.

In addition, a control unit 280 may be coupled to another side of the electrolyte bath 250 that is electrically connected with the anodes 260 and cathodes 265, and the anodes 260 and cathodes 265 may be coupled inside the electrolyte bath 250, so that a reaction for generating hydrogen may be performed from the electrolyte solution contained in the electrolyte bath.

A compound such as LiCl, KCl, NaCl, KNO₃, NaNO₃, CaCl₂, MgCl₂, K₂SO₄, Na₂SO₄, MgSO₄, AgCl, etc., can be used in the electrolyte solution, and the electrolyte solution may contain hydrogen ions.

While this embodiment presents an example in which the frame 210 of the filter 270, the electrolyte bath 250, and the outlet 255 are connected as a single structure, it is apparent that the invention encompasses such cases where the frame 210 of the filter 270, the electrolyte bath 250, and the outlet 255 are each fabricated as detached structures and are coupled by separate coupling means.

Furthermore, it is apparent that the invention encompasses such cases where the outlet 255 is formed as an integrated or single body with the electrolyte bath 250, and the frame 210 of the filter 270 is inserted inside the electrolyte bath 250 such that the covers 230 of the filter 270 are positioned in correspondence with the position of the outlet 255.

The anodes 260 may be active electrodes, and may be coupled inside the electrolyte bath 250 to generate electrons. The anodes 260 can be made, for example, of magnesium (Mg), and due to the difference in ionization tendency between the anodes 260 and hydrogen, the anodes 260 may release electrons into the water and may be oxidized into magnesium ions (Mg²⁺).

The electrons generated may travel to the control unit 280 electrically connected with the anodes 260, and to the cathodes 265 electrically connected with the control unit 280. As such, the anodes 260 may be expended in accordance with the electrons generated, and may have to be replaced after a certain period of time. Also, the anodes 260 may be made of a metal having a greater tendency to ionize than the material used for the cathodes 265 described below.

The cathodes 265 may be inactive electrodes and may not be expended, unlike the anodes 260, and thus the cathodes 265 may be implemented with a lower thickness than that of the anodes 260. The cathodes 265 may be coupled inside the electrolyte bath 250, and may receive the electrons generated at the anodes 260 to generate hydrogen. The cathodes 265 can be made, for example, of stainless steel, and may react with the electrons to generate hydrogen. That is, the chemical reaction at the cathodes 265 involves Water being dissociated to form hydrogen at the cathodes 265 after receiving the electrons from the anodes 260.

The reaction above can be represented by the following Reaction Scheme 1.

Anode 260: Mg→Mg²⁺+2e⁻

Cathode 265: 2H₂O+2e⁻H₂+2(OH)⁻

Overall Reaction: Mg+2H₂O→Mg(OH)₂+H₂ [Reaction Scheme 1]

The control unit 280 may be electrically connected with the anodes 260 and cathodes 265 to control the flow of electricity between the anodes 260 and cathodes 265. That is, the control unit 280 may be inputted with the amount of hydrogen required by the fuel cell, and if the required value is high, may increase the amount of electrons flowing from the anodes 260 to the cathodes 265, or if the required value is low, may decrease the amount of electrons flowing from the anodes 260 to the cathodes 265.

For example, the control unit 280 may include a variable resistance, to regulate the electric current flowing between the anodes 260 and cathodes 265 by varying the resistance value, or may include an on/off switch, to regulate the electric current flowing between the anodes 260 and cathodes 265 by controlling the on/off timing.

According to this embodiment, by using a filter 270 capable of removing moisture carried in hydrogen, a hydrogen generating apparatus can be provided that can supply pure hydrogen as required by a fuel cell, in a stable and efficient manner.

Next, an embodiment will be described of a fuel cell power generation system according to yet another aspect of the present invention.

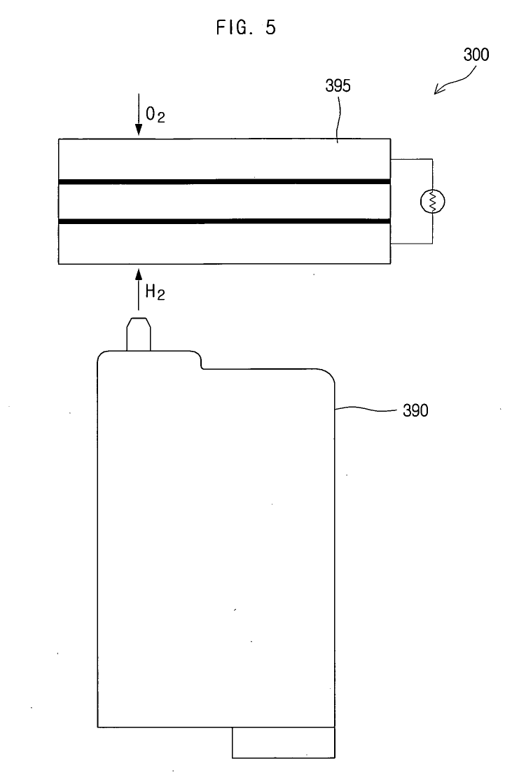

FIG. 5 is a schematic diagram illustrating an embodiment of a fuel cell power generation system according to yet another aspect of the present invention. In FIG. 5, there are illustrated a fuel cell power generation system 300, a hydrogen generator 390, and a fuel cell 395.

In this embodiment, a fuel cell system is presented, which produces electrical energy in a stable manner by removing the moisture carried in the gas using a desiccant supported by the frame and covers, to prevent the electrolyte solution in the electrolyte bath from flowing backward with the generated hydrogen.

In this embodiment, the composition of the hydrogen generator 390 is substantially the same as or is in correspondence with the composition of the embodiment described above for a hydrogen generator 200 (FIG. 3) according to another aspect of the invention, and thus will not be described again. The descriptions that follow will focus on the fuel cell 395, which forms the difference from the previously described embodiment.

The fuel cell 395 may convert the chemical energy of the hydrogen generated at the cathode to produce electrical energy. That is, the pure hydrogen generated in a hydrogen generator 390 equipped with a filter that removes moisture can be moved to the fuel electrode of the fuel cell 395, where the chemical energy of the hydrogen generated at the hydrogen generator 390 described above may be converted into electrical energy to produce a direct current.

According to this embodiment, an efficient and stable fuel cell power generation system 300 can be implemented, by supplying to the fuel cell 395 the hydrogen generated by the hydrogen generator 390 equipped with the filter to produce electrical energy.

As such, according to certain aspects of the invention set forth above, the backflow of the electrolyte solution, which may occur while generating hydrogen, can be prevented, by passing the hydrogen through a desiccant filled inside a frame, to consequently increase the hydrogen generating efficiency of the hydrogen generator.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A filter configured to remove moisture carried in a gas, the filter comprising:
a frame having an opening formed in each of two sides;
a cover coupled to the opening and having at least one hole formed therein to allow the gas to pass; and
a desiccant filled inside the frame and configured to absorb the moisture.

2. The filter of claim 1, wherein the desiccant comprises a plurality of porous grains.

3. The filter of claim 2, wherein the desiccant comprises at least one selected from a group consisting of silica, zeolite, microporous glass, and microporous charcoal.

4. The filter of claim 2, wherein the desiccant comprises an aerogel.

5. The filter of claim 4, wherein the desiccant comprises at least one of sulfur (S) and selenium (Se).

6. The filter of claim 2, wherein the size of the hole is smaller than a size of the porous grains.

7. The filter of claim 1, further comprising:
a detour plate inserted in the desiccant and configured to detour a movement path of the gas.

8. A hydrogen generator configured to dissociate an electrolyte solution to generate hydrogen, the hydrogen generator comprising:
an electrolyte bath containing the electrolyte solution;
an anode coupled to an inside of the electrolyte bath and configured to generate electrons;
a cathode coupled to an inside of the electrolyte bath and configured to receive the electrons from the anode to generate hydrogen;
a frame having the electrolyte bath coupled thereto and having an opening formed in each of two sides;
a cover coupled to the opening and having at least one hole formed therein to allow the hydrogen to pass through; and
a desiccant filled inside the frame and configured to absorb the electrolyte solution carried in the hydrogen.

9. The hydrogen generator of claim 8, wherein the desiccant comprises a plurality of porous grains.

10. The hydrogen generator of claim 9, wherein the desiccant comprises at least one selected from a group consisting of silica, zeolite, microporous glass, and microporous charcoal.

11. The hydrogen generator of claim 9, wherein the desiccant comprises an aerogel.

12. The hydrogen generator of claim 11, wherein the desiccant comprises at least one of sulfur (S) and selenium (Se).

13. The hydrogen generator of claim 9, wherein the size of the hole is smaller than a size of the porous grains.

14. The hydrogen generator of claim 9, further comprising:
a detour plate inserted in the desiccant and configured to detour a movement path of the hydrogen.

15. The hydrogen generator of claim 9, further comprising:
a control unit electrically connected with the anode and the cathode and configured to control a flow of electricity between the anode and the cathode.

16. A fuel cell power generation system configured to produce electrical energy using hydrogen generated by dissociating an electrolyte solution, the fuel cell power generation system comprising:
an electrolyte bath containing the electrolyte solution;
an anode coupled to an inside of the electrolyte bath and configured to generate electrons;
a cathode coupled to an inside of the electrolyte bath and configured to receive the electrons from the anode to generate hydrogen;
a frame having the electrolyte bath coupled thereto and having an opening formed in each of two sides;
a cover coupled to the opening and having at least one hole formed therein to allow the hydrogen to pass through;
a desiccant filled inside the frame and configured to absorb the electrolyte solution carried in the hydrogen; and
a fuel cell configured to convert a chemical energy of the hydrogen produced at the cathode to produce the electrical energy.

17. The fuel cell power generation system of claim 16, wherein the desiccant comprises a plurality of porous grains.

18. The fuel cell power generation system of claim 17, wherein the desiccant comprises at least one selected from a group consisting of silica, zeolite, microporous glass, and microporous charcoal.

19. The fuel cell power generation system of claim 17, wherein the desiccant comprises an aerogel.

20. The fuel cell power generation system of claim 19, wherein the desiccant comprises at least one of sulfur (S) and selenium (Se).

21. The fuel cell power generation system of claim 17, wherein the size of the hole is smaller than a size of the porous grains.

22. The fuel cell power generation system of claim 17, further comprising:
a detour plate inserted in the desiccant and configured to detour a movement path of the hydrogen.

23. The fuel cell power generation system of claim 17, further comprising:
a control unit electrically connected with the anode and the cathode and configured to control a flow of electricity between the anode and the cathode.
